(19) United States
(12) Patent Application Publication
(10) Pub. No.: US 2007/0283157 A1
(43) Pub. Date: Dec. 6, 2007

(54) System and method for enabling secure communications from a shared multifunction peripheral device

(75) Inventors: Sameer Yami, Irvine, CA (US); Amir Shahindoust, Laguna Niguel, CA (US)

Correspondence Address: TUCKER ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha

(21) Appl. No.: 11/446,742

(22) Filed: Jun. 5, 2006

(51) Int. Cl. H04L 9/00

(52) U.S. Cl. 713/175; 713/156; 713/173

(57) ABSTRACT

A system and method for enabling secure communications from a shared multifunction peripheral device is provided. The shared multifunction peripheral device first receives identification data representative of an associated user requesting a document processing operation. Upon authentication of the user, a key pair is generated by the shared multifunction peripheral device. The shared multifunction peripheral device also generates a limited operation certificate, restricting the user to a particular function offered by the shared multifunction peripheral device. The certificate is then stored by the shared multifunction peripheral device and the private key is encrypted using the received identification data. The public key and encrypted private key are then stored by the shared multifunction peripheral device. An electronic mail message is then generated by the shared multifunction peripheral device and digitally signed using the private key, whereupon it is transmitted to one or more designated recipients.

### CROSS REFERENCE TO RELATED APPLICATIONS

This application claims the benefit of priority of U.S. Provisional Application No. 60/734,743 filed Nov. 8, 2005.

### BACKGROUND OF THE INVENTION

The subject application is directed to a system and method for enabling secure communications from a shared multifunction peripheral device. More particularly, the subject application is directed to a system and method by which secure communication can be completed via a shared peripheral device, such as a multifunction peripheral. In the system and method of the subject application, a user is introduced through a stepped procedure to gain access to the shared peripheral device to allow for controlled access for secure message transmission. The system and method provides encryption through the use of electronic keys associated with the user without the user having to provide information regarding such keys to the multifunction peripheral device to which the user desires access.

A user of a multifunction peripheral device often desires to transmit an electronic document, message, or other communication to at least one selected recipient, such as an electronic mail address, remote printer, or facsimile device. Possible users of such a shared peripheral include new hires, authorized visitors, and the like. Newly installed peripherals that have messaging capability and new users to that peripheral or its associated domain require a mechanism that assures that the user is authorized prior to enabling such messaging capability. In order to maintain security of shared message transmission devices, earlier systems required users to login with a security code or other identification information, such as an electronic certificate associated with a user. Such a certificate typically required a user to transport it via a portable memory device, such as a smart card, memory stick, or the like. Additionally, there was no mechanism by which a new user to a domain could be granted access to send messages from a shared peripheral in a secure manner. Absent such security measures, any user can access the shared peripheral and commence a message transmission, such as an electronic mail.

The subject application overcomes the above mentioned problems and provides a system and method for enabling secure communications from a shared multifunction peripheral device.

### SUMMARY OF THE INVENTION

In accordance with the subject application, there is provided a system and method for enabling secure communications from a shared multifunction peripheral device.

Further, in accordance with the subject application, there is provided a system and method by which secure communication can be completed via a shared peripheral device, such as a multifunction peripheral.

Still further, in accordance with the subject application, there is provided a system and method wherein a user is introduced through a stepped procedure to gain access to the shared peripheral device to allow for controlled access for secure message transmission and provides encryption through the use of electronic keys associated with the user without the user having to provide information regarding such keys.

Still further, in accordance with the subject application, there is provided a system for enabling secure communications from a shared multifunction peripheral device. The system includes means adapted for receiving, into a shared multifunction peripheral device, identification data from an associated user and means adapted for generating key data corresponding to received identification data. The system also includes means adapted for generating a limited function certificate corresponding to a limited operation of the associated shared multifunction peripheral device by the associated user, wherein the limited function certificate corresponds to an enablement of the shared multifunction peripheral device for the limited operation. The system further includes means adapted for storing the generated limited function certificate in a storage associated with the shared multifunction peripheral device and means adapted for enabling the associated shared multifunction peripheral device for limited operation in accordance with the limited function certificate. The system also comprises means adapted for encrypting the key data and means adapted for enabling a message communication function for the associated user after encryption of the key data.

Still further, in accordance with the subject application, there is provided a method for enabling secure communications from a shared multifunction peripheral device. The method begins by receiving, into shared multifunction peripheral device, identification data from an associated user and generates key data corresponding to the received identification data. A limited function certificate corresponding to a limited operation of the associated shared multifunction peripheral device by the associated user is generated and stored in a storage associated with the shared multifunction peripheral device. The limited function certificate corresponds to an enablement of the shared multifunction peripheral device for the limited operation. The associated shared multifunction peripheral device is enabled for limited operation in accordance with the limited function certificate, the key data is encrypted, and a message communication is enabled for the associated user.

In a preferred embodiment, the message communication includes electronic mail. In another preferred embodiment, the limited operation includes a scanning operation.

In one embodiment of the subject application, the system and method further include the ability to test received identification data to determine whether the associated user has previously established credentials on a network associated with the shared multifunction peripheral device and receive single use identification data from the associated user in accordance with a determination that the associated user lacks previously established credentials.

In another embodiment, the system and method also include encrypting the limited function certificate in accordance with at least one of the identification data and the single use identification data. Preferably, the encrypting of the limited function certificate includes encrypting the limited function certificate in accordance with the single use identification data in accordance with a determination that the associated user lacks previously established credentials.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall system diagram of the system for enabling secure communications for a shared multifunction peripheral device according to the subject application;

FIG. 2 is a block diagram illustrating controller hardware for use in the system for enabling secure communications for a shared multifunction peripheral device according to the subject application;

FIG. 3 is a functional block diagram illustrating the controller for use in the system for enabling secure communications for a shared multifunction peripheral device according to the subject application;

FIG. 4 is a block diagram illustrating workstation hardware for use in the system for enabling secure communications for a shared multifunction peripheral device according to the subject application;

FIG. 5 is a flowchart illustrating the method for enabling secure communications for a shared multifunction peripheral device for a user with a network identification according to the subject application; and

FIG. 6 is a flowchart illustrating the method for enabling secure communications for a shared multifunction peripheral device for a user without a network identification according to the subject application.

### DETAILED DESCRIPTION OF THE PREFERRED EMBODIMENT

The subject application is directed a system and method for enabling secure communications from a shared multifunction peripheral device. In particular, the subject application is directed to a system and method by which secure communication can be completed via a shared peripheral device. More particularly, the subject application is directed to a system and method wherein a user is introduced through a stepped procedure to gain access to the shared peripheral device to allow for controlled access for secure message transmission and provides encryption through the use of electronic keys associated with the user without the user having to provide information regarding such keys. It will be appreciated by those skilled in the art that throughout this description reference is made to the use of the instant application for a scan-to-electronic mail operation; however the skilled artisan will understand that other document processing operations, including for example and without limitation, facsimile, print, copy, scan-to-storage, and the like, are equally capable of employing the subject application.

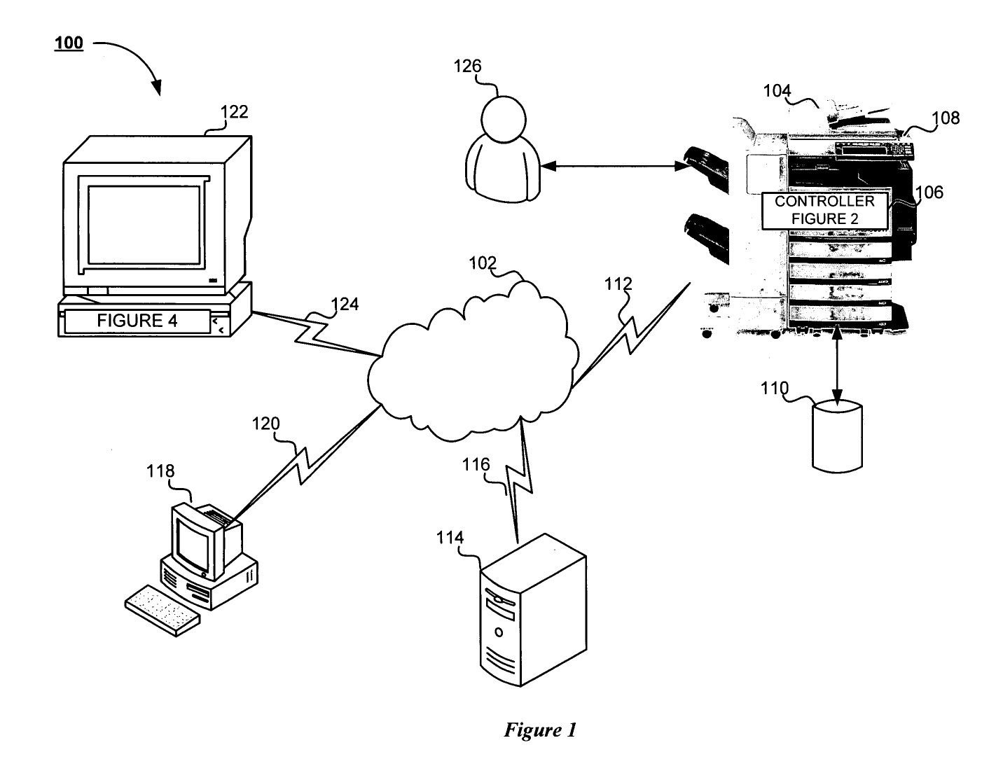

Referring now to FIG. 1, there is shown an overall system diagram of a system 100 for enabling secure communications for a shared multifunction peripheral device in accordance with the subject application. As depicted in FIG. 1, the system 100 employs a distributed computing environment, represented as a computer network 102. It will be appreciated by the skilled artisan that the computer network 102 is any distributed communications environment known in the art capable of allowing two or more electronic devices to exchange data. Those skilled in the art will understand that the computer network 102 is any computer network, known in the art, including for example, and without limitation, a local area network, a wide area network, a personal area network, a virtual network, an intranet, the Internet, or any combination thereof. In the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wire-based or wireless data communication mechanisms.

The system 100 includes at least one shared multifunction peripheral device 104. It will be understood by those skilled in the art the shared multifunction peripheral device 104 is suitably adapted to provide a variety of document processing services, such as, for example and without limitation, electronic mail, scanning, copying, facsimile, document management, printing, and the like. Suitable commercially available shared multifunction peripheral devices include, but are not limited to, the Toshiba e-Studio Series Controller. In one embodiment, the shared multifunction peripheral device 104 is suitably equipped to receive a plurality of portable storage media, including without limitation, Firewire drive, USB drive, SD, MMC, XD, Compact Flash, Memory Stick, and the like. In the preferred embodiment of the subject application, the shared multifunction peripheral device 104 further includes an associated user-interface 108, such as a touch-screen interface, LCD display, or the like, via which an associated user 126 is able to interact directly with the shared multifunction peripheral device 104. In accordance with the preferred embodiment of the subject application, the shared multifunction peripheral device 104 further includes a data storage device 110, communicatively coupled to the shared multifunction peripheral device 104, suitably adapted to provide document storage, user information storage, user certificate storage, and the like. As will be understood by those skilled in the art, the data storage device 110 is any mass storage device known in the art including, for example and without limitation, a hard disk drive, other magnetic storage devices, optical storage devices, flash memory devices, or any combination thereof.

In accordance with one embodiment of the subject application, the shared multifunction peripheral device 104 is in data communication with the computer network 102 via a suitable communications link 112. As will be appreciated by the skilled artisan, a suitable communications link 112 employed in accordance with the subject application includes, WiMax, 802.11a, 802.11b, 802.11g, 802.11(x), Bluetooth, the public switched telephone network, a proprietary communications network, infrared, optical, or any other suitable wired or wireless data transmission communications known in the art.

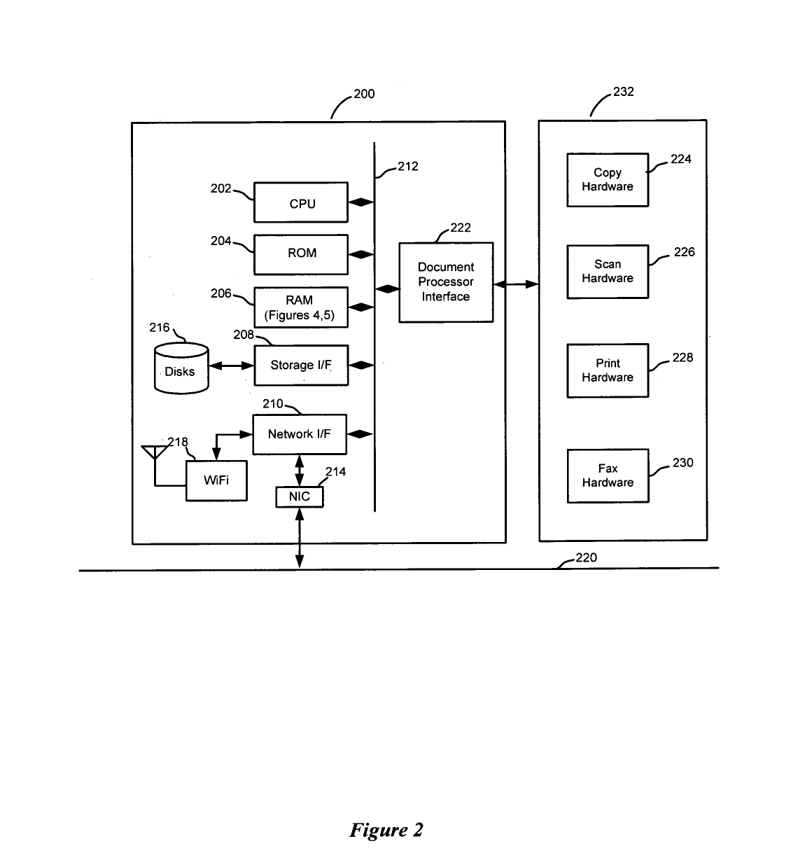

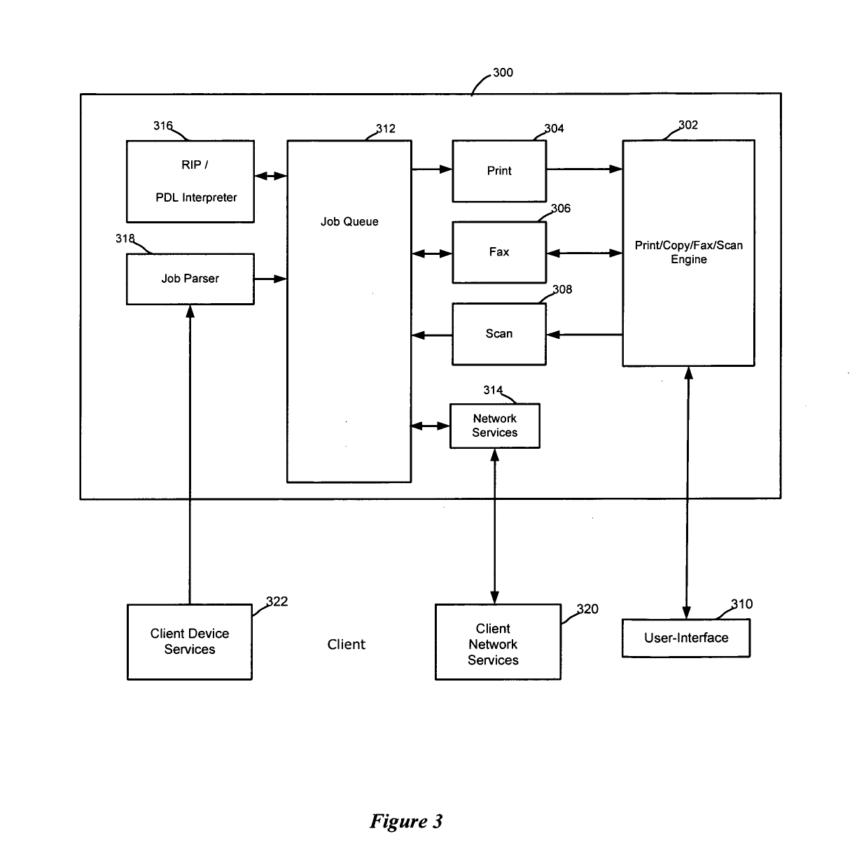

In accordance with the subject application, the document processing device 104 further incorporates a controller 106, suitably adapted to facilitate the operations of the document processing device 104, as will be understood by those skilled in the art. Preferably, the controller 106 is embodied as hardware, software, or any suitable combination thereof, configured to control the operations of the associated document processing device 104, control the display of images via the user-interface 108, analyze received coupon data, facilitate communications with external devices, and the like. While the controller 106 is depicted in FIG. 1 as being an integrated component of the document processing device 104, the skilled artisan will appreciate that the controller 106 is suitably capable of being implemented as an external device, communicatively coupled to the document processing device 104. The functioning of the controller 106 will better be understood in conjunction with the block diagrams illustrated in FIGS. 2 and 3, explained in greater detail below.

As shown in FIG. 1, the system 100 also employs an authentication server 114, communicatively coupled to the computer network 102 via a communications link 116. The skilled artisan will appreciate that the authentication server 114 is any software, hardware, or combination thereof, suitably adapted to provide authentication services to the computer network 102. Preferably, the authentication server 114 advantageously provides verification of user identities, rights, passwords and the like. As will be understood by those skilled in the art, the authentication server 114 is capable of employing any verification and authentication methods, known in the art. The communications link 116 is any suitable means of data communication known in the art, including, for example and without limitation, infrared, optical, a proprietary communications network, the public switched telephone network, Bluetooth, WiMax, 802.11a, 802.11b, 802.11g, or 802.11(x), or any other suitable wire-based or wireless data transmission means known in the art. In the preferred embodiment of the subject application, the communications link 116 is suitably adapted to provide a secure communications channel between the authentication server 114 and any other electronic device coupled to the computer network 102, as will be appreciated by those skilled in the art. Preferably, the communications link 116, so as to ensure the security of the user authentication information that is verified by the authentication server 114, is implemented using data security protocols, such as web security protocols, in accordance with the subject application.

FIG. 1 further illustrates an administrator device 118, in data communication with the computer network 102 via a communications link 120. It will be appreciated by those skilled in the art that the use of the administrator device 118 is for example purposes only, and a network or system administrator is equally capable of functioning in accordance with the subject application. The use of the administrator device 118 is made solely to avoid confusion between the user 126, as shown in FIG. 1, having non-administrative or no access rights to the computer network 102, and the user (represented by the device 118) having administrative or total access rights to the computer network 102. In accordance with the use of the administrator device 118 as representative of an individual having administrative rights and controls over devices resident on the computer network 102, the administrator device 118 is suitably adapted to perform a variety of tasks, as will be appreciated by those skilled in the art. For example, the administrator device 118 is capable, upon the request of a new user, of generating a new network identification/password combination, a temporary network identification, and the like. The communications link 120 is any suitable data communications channel known in the art including, for example and without limitation, 802.11(x), infrared, Bluetooth, a proprietary communications network, the public switched telephone network, optical, or any other suitable wire-based or wireless data transmission means known in the art.

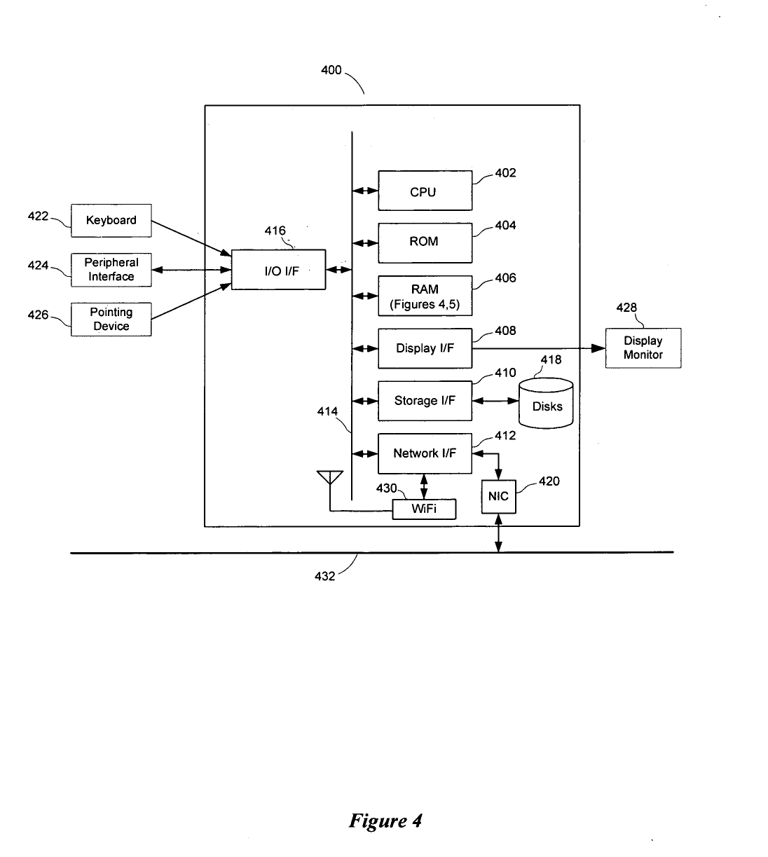

The system 100 illustrated in FIG. 1 further includes at least one client device, depicted as a computer workstation 122. Preferably, the client device, or workstation 122, is communicatively coupled to the computer network 102 via a suitable communications link 124. It will be appreciated by those skilled in the art that the client: device is depicted in FIG. 1 as a computer workstation 122 for illustration purposes only. As the skilled artisan will understand, the workstation 122 shown in FIG. 1 is representative of any personal computing device known in the art, including, for example and without limitation, a laptop computer, a personal computer, a personal data assistant, a web-enabled cellular telephone, a smart phone, or other web-enabled electronic device. The functioning of the workstation 122 will be better understood when viewed in conjunction with the block diagram illustrated in FIG. 4. The communications link 124 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art.

Turning now to FIG. 2, illustrated is a representative architecture of a suitable controller 200, depicted in FIG. 1 as the controller 106, on which operations of the subject system 100 are completed. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. Network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and network interface subsystem 210 is suitably accomplished via a bus data transfer mechanism, such as illustrated by bus 212.

Also in data communication with the bus 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device that includes the controller 200 of FIG. 2 as an intelligent subsystem associated with a document processing device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably via an interface local to the controller, or remotely via a remote thin or thick client.

The engine 302 is in data communication with printer function 304, facsimile function 306, and scan function 308. These devices facilitate the actual operation of printing, facsimile transmission and reception, and document scanning for use in securing document images for copying or generating electronic versions.

A job queue 312 is suitably in data communication with printer function 304, facsimile function 306, and scan function 308. It will be appreciated that various image forms, such as bit map, page description language or vector format, and the like, are suitably relayed from scan function 308 for subsequent handling via job queue 312.

The job queue 312 is also in data communication with network services 314. In a preferred embodiment, job control, status data, or electronic document data is exchanged between job queue 312 and network services 314. Thus, suitable interface is provided for network based access to the controller 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. Network services 314 also advantageously supplies data interchange with client side services 320 for communication via FTP, electronic mail, TELNET, or the like. Thus, the controller function 300 facilitates output or receipt of electronic document and user information via various network access mechanisms.

Job queue 312 is also advantageously placed in data communication with an image processor 316. Image processor 316 is suitably a raster image process, page description language interpreter or any suitable mechanism for interchange of an electronic document to a format better suited for interchange with device services such as printing 304, facsimile 306 or scanning 308.

Finally, job queue 312 is in data communication with a parser 318, which parser suitably functions to receive print job language files from an external device, such as client device services 322. Client device services 322 suitably include printing, facsimile transmission, or other suitable input of an electronic document for which handling by the controller function 300 is advantageous. Parser 318 functions to interpret a received electronic document file and relay it to a job queue 312 for handling in connection with the afore-described functionality and components.

Turning now to FIG. 4, illustrated is a hardware diagram of a suitable workstation 400, shown in FIG. 1 as the workstation 122, for use in connection with the subject system 100. A suitable workstation includes a processor unit 402 which is advantageously placed in data communication with read only memory 404, suitably non-volatile read only memory, volatile read only memory or a combination thereof, random access memory 406, display interface 408, storage interface 410, and network interface 412. In a preferred embodiment, interface to the foregoing modules is suitably accomplished via a bus 414.

Read only memory 404 suitably includes firmware, such as static data or fixed instructions, such as BIOS, system functions, configuration data, and other routines used for operation of the workstation 400 via CPU 402.

Random access memory 406 provides a storage area for data and instructions associated with applications and data handling accomplished by processor 402. Display interface 408 receives data or instructions from other components on bus 414, which data is specific to generating a display to facilitate a user interface. Display interface 408 suitably provides output to a display terminal 426, suitably a video display device such as a monitor, LCD, plasma, or any other suitable visual output device as will be appreciated by one of ordinary skill in the art.

Storage interface 410 suitably provides a mechanism for non-volatile, bulk or long term storage of data or instructions in the workstation 400. Storage interface 410 suitably uses a storage mechanism, such as storage 418, suitably comprised of a disk, tape, CD, DVD, or other relatively higher capacity addressable or serial storage medium.

Network interface 412 suitably communicates to at least one other network interface, shown as network interface 420, such as a network interface card, and wireless network interface 430, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by on of ordinary skill in the art. In the illustration, the network interface 420 is interconnected for data interchange via a physical network 432, suitably comprised of a local area network, wide area network, or a combination thereof.

An input/output interface 416 in data communication with bus 414 is suitably connected with an input device 422, such as a keyboard or the like. Input/output interface 416 also suitably provides data output to a peripheral interface 424, such as a USB, universal serial bus output, SCSI, Firewire (IEEE 1394) output, or any other interface as may be appropriate for a selected application. Finally, input/output interface 416 is suitably in data communication with a pointing device interface 428 for connection with devices, such as a mouse, light pen, touch screen, or the like.

In operation, a user 126, as illustrated in FIG. 1, is capable of initiating a document processing request via the workstation 122, or more preferably directly via the user-interface 108 associated with the shared multifunction peripheral device 104. Irrespective of the origination of the request, a determination must first be made as to whether or not the user 126 has a valid network identification. The skilled artisan will appreciate that the determination of a valid network identification is advantageously made using identification data supplied by the user 126 at the shared multifunction peripheral device 104 during login. That is, prior to requesting a particular document processing operation, the user 126 must first provide identification information to the shared multifunction peripheral device 104. In the preferred embodiment, this identification information takes the form of the user 126 network identification and/or password. In accordance with the preferred embodiment of the subject application, the operation requested is a scan-to-electronic mail operation, wherein the keys generated hereinafter are available for use by the user 126 in subsequent scan-to-electronic mail operations. The skilled artisan will appreciate that the subject application need not be limited solely to scan-to-electronic mail messages and is equally adaptable to a variety of document processing operations performed by the shared multifunction peripheral device 104.

Upon receipt of the user 126 identification information, the controller 106 associated with the shared multifunction peripheral device 104 transmits the received data to the authentication server 114 for verification. When the identification supplied by the user 126 cannot be verified against previously stored user information, the authentication server 114 returns an error signal to the controller 106 associated with the shared multifunction peripheral device 104, which thereafter notifies the user 126 of the invalidity of the identification information. When the authentication server 114 determines that the network identification supplied by the user 126 to the shared multifunction peripheral device 104 is authentic, verification is returned to the shared multifunction peripheral device 104. The controller 106 associated with the shared multifunction peripheral device 104 then generates a public/private encryption key pair. It will be appreciated by those skilled in the art that any means of randomly generating public/private encryption keys, known in the art, is capable of being employed in accordance with the subject application.

The controller 106 associated with the shared multifunction peripheral device 104 then generates a limited operation certificate, corresponding to a selected document processing operation, e.g., scan-to-electronic mail, which is only usable by the user 126 on the shared multifunction peripheral device 104. The skilled artisan will appreciate that the limited operation certificate generated by the controller 106 will restrict the user 126 to only performing the operation delineated by the certificate at the selected shared multifunction peripheral device 104. It will be apparent to those skilled in the art that this limited certificate is secondary to any certificates resident on the workstation 122, to which the user 126 is associated. Preferably, the limited operation certificate is stored in the data storage device 110. The private key of the generated key pair is then encrypted using the submitted identification data, i.e., the network identification and/or password. The shared multifunction peripheral device 104 then performs the selected document processing operation, e.g., the scanning of a hardcopy into an electronic format for transmittal as an electronic mail message. The user 126 is then able to complete the desired document processing operation, the scan-to-electronic mail, by using the private key to digitally sign the message. The signed message, incorporating the scanned document, is then sent to one or more designated recipient addresses.

When the user 126 does not have a network identification, i.e., is a new user, a temporary user, or the like, the user 126 first requests access to the shared multifunction peripheral device 104 from a system or network administrator, represented by the administrator device 118. The administrator device 118 then generates temporary, or single use, identification data to be used by the user 126 for the requested access. Preferably, the single user identification data corresponds to a password or user personal identification number, which the administrator device 118 communicates to the authentication server 114. More preferably, the administrator device 118 includes, with the temporary identification data, data representative of limitations as to the number of operations the user 126 is able to request, the type of operation, the size of a document processing request, or the like. The temporary identification data is then issued to the requesting user 126 via any suitable means. In accordance with the preferred embodiment of the subject application, the user 126 inputs the received temporary identification data at the user-interface 108 associated with the shared multifunction peripheral device 104.

The controller 106 associated with the shared multifunction peripheral device 104 then transmits the received identification data to the authentication server 114 for verification. When the authentication server 114 determines that the identification data received from the shared multifunction peripheral device 104 is invalid, i.e., does not match the data previously input by the administrator device 118, the shared multi function peripheral device 104 is informed of the error, which then notifies the user 126 of the problem. When the identification data is determined to be valid, the controller 106 associated with the shared multifunction peripheral device 104 generates a public/private encryption key pair via any suitable means known in the art. A temporary limited operation certificate is then generated by the controller 106 associated with the shared multifunction peripheral device 104 and issued to the user 126. The skilled artisan will appreciate that the certificate thereby issued limits the user 126 to a predetermined operation, as set forth by the administrator, e.g., scan-to-electronic mail. The use of such a certificate, as will be appreciated by those skilled in the art, restricts the user 126 only to the authorized function of the shared multifunction peripheral device 104, preventing the user 126 from making copies, sending faxes, or the like, without further administrator interaction. The temporary limited operation certificate is then stored in the data storage device 110 associated with the shared multifunction peripheral device 104.

Thereafter, the private key is encrypted using the temporary identification information, i.e., the temporary personal identification number, and the shared multifunction peripheral device 104 performs the document processing operation as set forth by the certificate. That is, the shared multifunction peripheral device 104 scans a hardcopy, thereby generating electronic image data representative of that hardcopy and attaches the same to an electronic mail message. The electronic mail message is then digitally signed using the recently generated private key of the user 126 and sent to one or more designated recipients, thereby providing those recipients with the ability to verify the identity of the sender (user 126).

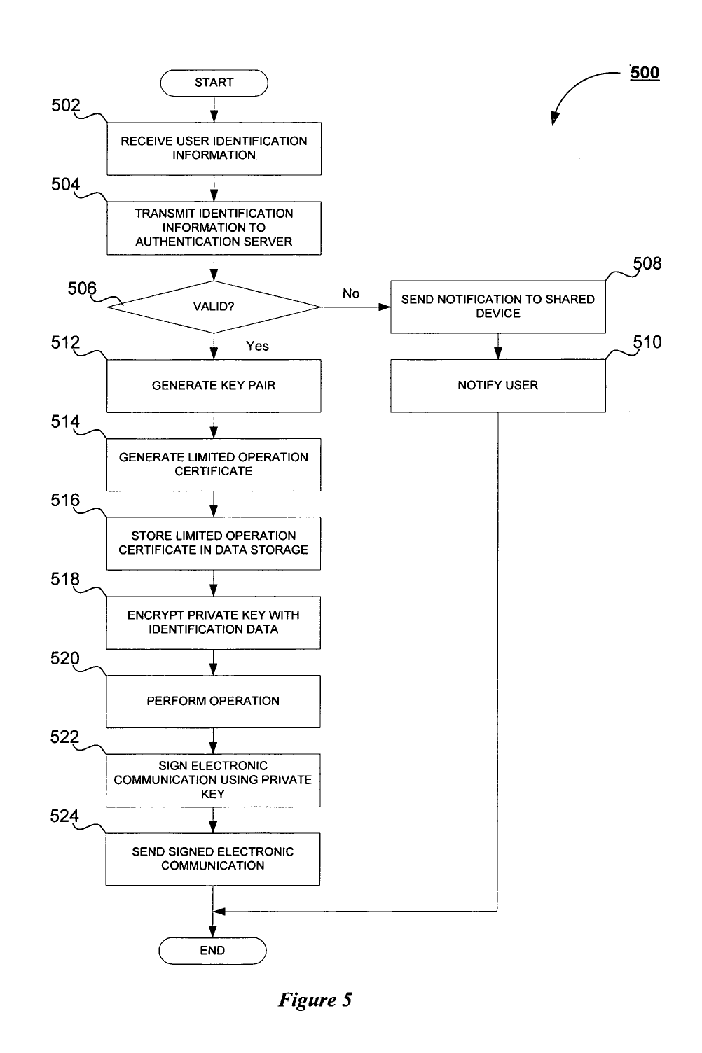

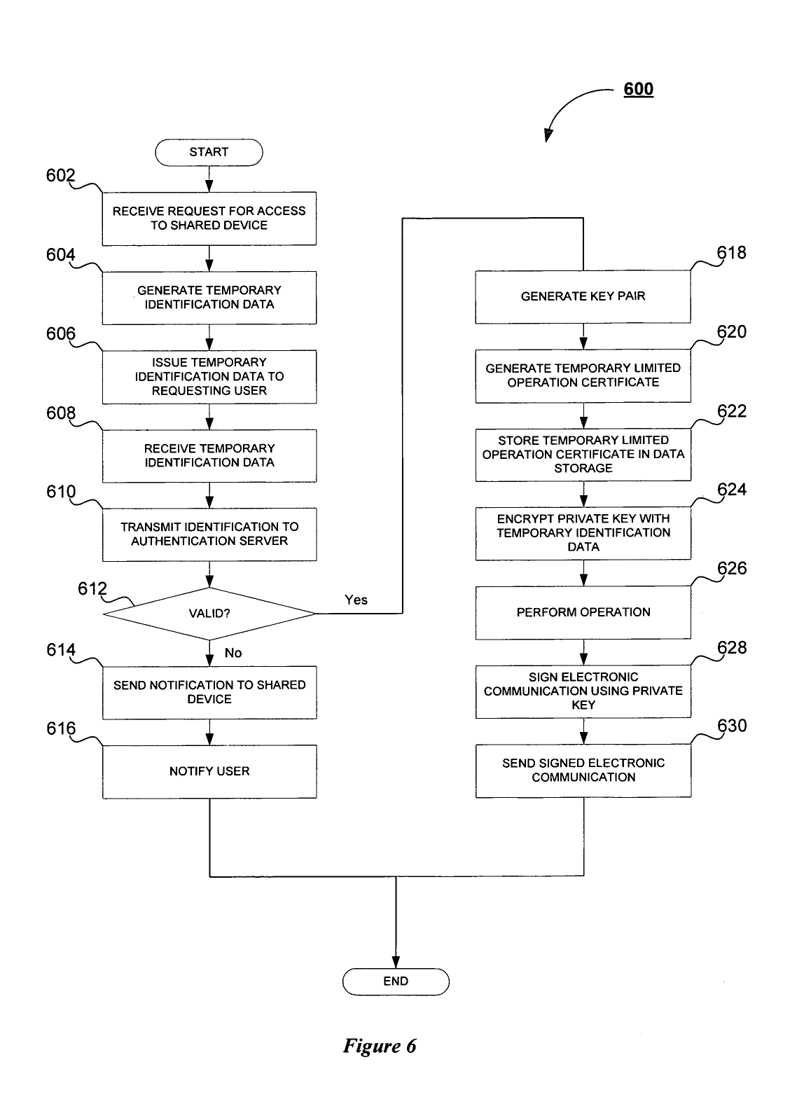

The foregoing system 100 and components illustrated in FIG. 1, FIG. 2, FIG. 3, and FIG. 4 will better be understood when viewed in conjunction with the methodologies set forth in FIG. 5 and FIG. 6, discussed hereinafter.

Turning now to FIG. 5, there is shown a flowchart 500 illustrating a method for enabling secure communications for a shared multifunction peripheral device for a user with a network identification in accordance with the subject application. Beginning at step 502, the shared multifunction peripheral device 104 receives user identification data via any suitable means. In the preferred embodiment of the subject application, the user 126 inputs a network identification and/or password, via the user-interface 108 associated with the shared multifunction peripheral device 104. The skilled artisan will appreciate that the identification data received by the shared multifunction peripheral device 104 suitably includes data representative of a selected document processing operation, e.g., the scan-to-electronic mail document processing operation. The skilled artisan will appreciate that the use of the scan-to-electronic mail document processing operation is for example purposes only, and other document processing operations, including for example and without limitation, facsimile, print, copy, scan-to-storage, and the like, are equally capable of employing the subject application. The received identification data is then transmitted at step 504 to an authentication server 114. Preferably, the communication of the identification data from the shared multifunction peripheral device 104 to the authentication server 114 is accomplished via a secure communications channel, as will be appreciated by those skilled in the art.

Once the authentication server 114 has received the identification data, the server 114 determines at step 506 whether the data is valid. That is, the authentication server 114 determines whether the network identification and/or password provided by the user 126 as the identification data matches the network identification/password data stored by the server 114. When the server 114 determines at step 506 that the submitted identification information is invalid, flow proceeds to step 508, whereupon the authentication server 114 returns an error notification to the shared multifunction peripheral device 104. The user 126 is then notified by the controller 106 associated with the shared multifunction peripheral device 104 via any suitable means of the error at step 510.

When the identification data is authenticated by the authentication server 114 at step 506, the controller 106 associated with the shared multifunction peripheral device 104 is informed of the validation and generates, at step 212, a public/private encryption key pair. It will be understood by the skilled artisan that any method for generating encryption keys, known in the art, is capable of being employed in accordance with the subject application. At step 514, the controller 106 associated with the shared multifunction peripheral device 104 generates and issues a limited operation certificate corresponding to the operation to be performed by the shared multifunction peripheral device 104, for example, the scan-to-electronic mail document processing operation. In accordance with one embodiment of the subject application, the limited operation certificate includes data representative of a limited number of operations to be performed, a job size limit, an operation type restriction, or the like. The limited operation certificate is then stored at step 516 on the data storage device 110 associated with the shared multifunction peripheral device 104. The private key is then encrypted using the identification data received from the user 126 by the controller 106 associated with the shared multifunction peripheral device 104 at step 518. In accordance with one particular embodiment of the subject application, the public key and the encrypted private key are then stored in the associated data storage device 110, as encrypted, for later use by the user 126.

At step 520 the shared multifunction peripheral device 104 performs the selected document processing operation. The skilled artisan will appreciate that at step 520, the shared multifunction peripheral device 104 generates electronic image data representative of a hardcopy of a document placed on a scanning component or automatic document feeder associated with the shared multifunction peripheral device 104. Thereafter, the electronic image data is added to an electronic mail message, generated concurrently at step 520 in accordance with the selected operation. At step 522, the electronic communication, i.e., the electronic mail message, is digitally signed using the private key via any suitable means known in the art. The signed electronic communication, inclusive of the scanned image data, is then transmitted to one or more designated recipients at step 524, whereupon the operation ends.

FIG. 6 illustrates a flowchart 600 depicting a method for enabling secure communications for a shared multifunction peripheral device for a user without a network identification in accordance with the subject application. At step 602, the administrator device 118 receives a request for access to perform a scan-to-electronic mail operation from a user 126. It will be understood by those skilled in the art that the request is capable of being received via an electronic communication from the user 126 to the administrator device 118, from the user 126 to an administrative user associated with the administrator device 118, or the like. The skilled artisan will further appreciate that the document processing request need not be limited solely to the scan-to-electronic mail document processing operation, and other document processing operations, including for example and without limitation, facsimile, print, copy, scan-to-storage, and the like, are equally capable of employing the subject application.

The administrator device 118 then generates, at step 604, temporary, or single use, identification data associated with the user 126 requesting access to the shared multifunction peripheral device 104. Preferably, the administrator device 118 generates a temporary network identification and/or password for use by the user 126 for a limited time, a limited number of operations, or both. The skilled artisan will appreciate that when the administrator device 118 generates the temporary identification data, the device 118 registers the data with the authentication server 114 via a secure communications link. The administrator device 118 then issues the temporary identification data to the requesting user 126 at step 606 via any suitable means known in the art. Suitable means includes, for example and without limitation, an electronic communication containing the identification data, a hardcopy of the identification data, or the like.

At step 608, the shared multifunction peripheral device 104 receives the temporary identification data via the associated user-interface 108. The controller 106 associated with the shared multifunction peripheral device 104 then transmits the received identification data to the authentication server 114 at step 610. Preferably, the transmission of the identification data occurs using a secure communications channel, as will be understood by those skilled in the art. The authentication server 114 then determines, at step 612, whether the temporary identification data is authentic. That is, the authentication server 114 determines whether the temporary identification data received from the shared multifunction peripheral device 104 matches the temporary identification data received from the administrator device 118. When the authentication server 114 determines that the data received from the shared multifunction peripheral device 104 is invalid, flow proceeds to step 614, whereupon an error notification is returned to the sending shared multifunction peripheral device 104. The controller 106 associated with the shared multifunction peripheral device 104 then notifies the user 126 of the invalid identification data at step 616, whereupon the operation terminates.

When it is determined by the authentication server 114 that the temporary identification data is valid, an acknowledgement as to the validity of such data is returned to the sending shared multifunction peripheral device 104. At step 618, the shared multifunction peripheral device 104 generates a public/private encryption key pair via any suitable means known in the art. The controller 106 associated with the shared multifunction peripheral device 104 then generates a temporary limited operation certificate corresponding to the scan-to-electronic mail operation authorized by the administrator at step 620. It will be appreciated by those skilled in the art that the certificate is capable of being restricted in duration, number of operations, type of operation, or the like. The temporary limited operation certificate is then stored in the associated data storage device 110 at step 622. At step 624, the controller 106 associated with the shared multifunction peripheral device 104 encrypts the private key of the generated key pair using the temporary identification data, thereby restricting access to the private key to the associated user 126. In accordance with one embodiment of the subject application, the public key and the encrypted private key are then stored in the associated data storage device 110 for later use by the associated user 126. The scan-to-electronic mail operation is then performed at step 626 such that electronic image data representative of a hardcopy of a document is generated from a document placed on a scanning component or automatic document feeder of the shared multifunction peripheral device 104. Concurrently with the generation of the electronic image data, an electronic communication is generated, i.e., an electronic mail message, wherein the image data is included. The electronic communication is then digitally signed using the private key of the associated user 126 at step 628 and the communication is transmitted to one or more designated recipients at step 630.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for enabling secure communications from a shared multifunction peripheral device comprising:
means adapted for receiving, into a shared multifunction peripheral device, identification data from an associated user;
means adapted for generating key data corresponding to received identification data;
means adapted for generating a limited function certificate corresponding to a limited operation of the associated shared multifunction peripheral device by the associated user, wherein the limited function certificate corresponds to an enablement of the shared multifunction peripheral device for the limited operation;
means adapted for storing the generated limited function certificate in a storage associated with the shared multifunction peripheral device;
means adapted for enabling the associated shared multifunction peripheral device for limited operation in accordance with the limited function certificate;
means adapted for encrypting the key data; and
means adapted for enabling a message communication function for the associated user after encryption of the key data.

2. The system for enabling secure communications from a shared multifunction peripheral device of claim 1 further comprising:
testing means adapted for testing received identification data to determine whether the associated user has previously established credentials on a network associated with the shared multifunction peripheral device; and
means adapted for receiving single use identification data from the associated user in accordance with a determination by the testing means that the associated user lacks previously established credentials.

3. The system for enabling secure communications from a shared multifunction peripheral device of claim 2 further comprising encryption means adapted for encrypting the limited function certificate in accordance with at least one of the identification data and the single use identification data.

4. The system for enabling secure communications from a shared multifunction peripheral device of claim 3, wherein the encryption means includes means adapted for encrypting the limited function certificate in accordance with the single use identification data in accordance with a determination by the testing means that the associated user lacks previously established credentials.

5. The system for enabling secure communications from a shared multifunction peripheral device of claim 1, wherein the message communication function includes electronic mail.

6. The system for enabling secure communications from a shared multifunction peripheral device of claim 1 wherein the limited operation includes a scanning operation.

7. A method for enabling secure communications from a shared multifunction peripheral device comprising the steps of:
receiving, into a shared multifunction peripheral device, identification data from an associated user;
generating key data corresponding to received identification data;
generating a limited function certificate corresponding to a limited operation of the associated shared multifunction peripheral device by the associated user, wherein the limited function certificate corresponds to an enablement of the multifunctional peripheral device for the limited operation;
storing the generated limited function certificate in a storage associated with the shared multifunction peripheral device;
enabling the associated multifunction peripheral device for limited operation in accordance with the limited function certificate;
encrypting the key data; and
enabling a message communication function for the associated user after encryption of the key data.

8. The method for enabling secure communications from a shared multifunction peripheral device of claim 7 further comprising the steps of:
testing received identification data to determine whether the associated user has previously established credentials on a network associated with the shared multifunction peripheral device; and
receiving single use identification data from the associated user in accordance with a determination that the associated user lacks previously established credentials.

9. The method for enabling secure communications from a shared multifunction peripheral device of claim 8 further comprising the step of encrypting the limited function certificate in accordance with at least one of the identification data and the single use identification data.

10. The method for enabling secure communications from a shared multifunction peripheral device of claim 9, wherein the step of encrypting includes encrypting the limited function certificate in accordance with the single use identification data in accordance with a determination that the associated user lacks previously established credentials.

11. The method for enabling secure communications from a shared multifunction peripheral device of claim 7 wherein the message communication function includes electronic mail.

12. The method for enabling secure communications from a shared multifunction peripheral device of claim 7 wherein the limited operation includes a scanning operation.

13. A computer-implemented method for enabling secure communications from a shared multifunction peripheral device comprising the steps of:
receiving, into a shared multifunction peripheral device, identification data from an associated user;
generating key data corresponding to received identification data;
generating a limited function certificate corresponding to a limited operation of the associated shared multifunction peripheral device by the associated user, wherein the limited function certificate corresponds to an enablement of the multifunctional peripheral device for the limited operation;
storing the generated limited function certificate in a storage associated with the shared multifunction peripheral device;
enabling the associated multifunction peripheral device for limited operation in accordance with the limited function certificate;
encrypting the key data; and
enabling a message communication function for the associated user after encryption of the key data.

14. The computer-implemented method for enabling secure communications from a shared multifunction peripheral device of claim 13 further comprising the steps of:
testing received identification data to determine whether the associated user has previously established credentials on a network associated with the shared multifunction peripheral device; and
receiving single use identification data from the associated user in accordance with a determination that the associated user lacks previously established credentials.

15. The computer-implemented method for enabling secure communications from a shared multifunction peripheral device of claim 14 further comprising the step of encrypting the limited function certificate in accordance with at least one of the identification data and the single use identification data.

16. The computer-implemented method for enabling secure communications from a shared multifunction peripheral device of claim 15 wherein the step of encrypting includes encrypting the limited function certificate in accordance with the single use identification data in accordance with a determination that the associated user lacks previously established credentials.

17. The computer-implemented method for enabling secure communications from a shared multifunction peripheral device of claim 13 wherein the message communication function includes electronic mail.

18. The computer-implemented method for enabling secure communications from a shared multifunction peripheral device of claim 13 wherein the limited operation includes a scanning operation.
